(19) United States
(12) Patent Application Publication
(10) Pub. No.: US 2026/0061866 A1
(43) Pub. Date: Mar. 5, 2026

(54) CHARGER

(71) Applicant: LG ELECTRONICS INC., Seoul (KR)

(72) Inventors: Junyeop JEONG, Seoul (KR); Kangsuk LEE, Seoul (KR); Jiho LEE, Seoul (KR); Sunghwan OH, Seoul (KR); Myoungku LEE, Seoul (KR)

(73) Assignee: LG ELECTRONICS INC., Seoul (KR)

(21) Appl. No.: 19/198,815

(22) Filed: May 5, 2025

(30) Foreign Application Priority Data
Sep. 2, 2024 (KR) 10-2024-0118763

(51) Int. Cl. B60L 53/302

(52) U.S. Cl. CPC B60L 53/302

(57) ABSTRACT

A charger includes a cabinet body having a first side plate, a second side plate spaced apart from the first side plate in a first direction, and a rear plate, the rear plate including a suction port configured to allow air to be suctioned therethrough. The first side plate, the second side plate and the rear plate defining an inner space of the cabinet. The charger further including a filter located adjacent to an inner side of the first side plate, the filter being tilted toward a front surface of the rear plate.

### CROSS-REFERENCE TO RELATED APPLICATIONS

This application claims the benefit of priority to Korean Patent Application No. 10-2024-0118763, filed in the Republic of Korea on Sep. 2, 2024, the entire contents of which is expressly incorporated herein by reference.

### BACKGROUND

The present disclosure relates to a charger capable of charging a vehicle.

A charger is a device used to charge a battery.

The charger may be an electric vehicle charger that charges a vehicle such as an electric vehicle, and may supply electric energy to the battery of the electric vehicle by connecting a connector provided at the end part of a charging cable to a connection inlet installed in the electric vehicle.

The user pulls out the connector (charging gun or plug) provided on the charging cable from the body of the charger, and then may connect the vehicle.

The charger may comprise a filter. For example, Korean Patent Publication No. 10-2023-0089366 A (published on Jun. 20, 2023), discloses a filter module that is fastened to a front door of an electric vehicle rapid charger and removes salt contained in air flowing into the inside of the charger. The filter module comprises a pair of first plate filters and a second plate filter having a plurality of buffer holes of a slit structure, and a metal filter part in which the first buffer holes of the first plate filter and the second buffer holes of the second plate filter are disposed to be misaligned from each other. A media filter part having a dual media structure includes a pair of first media filters and second media filters disposed at the rear surface of a metal filter part. The first media filter is folded in a zigzag structure to form a plurality of adjacent slits, and the plurality of second media filters are folded in a pleated structure to form long through-holes in the direction of air movement, and are inserted into and coupled with each slit formed by the first media filter. A protective frame is coupled along the outer peripheral surface of the edge of the media filter part while forming a square frame structure. A fastening guide is fastened to the front door by accommodating a media filter part coupled with a metal filter part and a frame part while forming a square frame structure.

### SUMMARY

An object of this embodiment is to provide a charger that is advantageous in waterproofing and has a slim outer appearance.

A charger according to the present embodiment comprises a cabinet body comprising a pair of side plates and a rear plate; and a filter disposed to be tilted toward the front surface of the rear plate.

The pair of side plates and a rear plate form an inner space.

The filter is disposed next to an inner side of one of the pair of side plates.

A suction port through which air is suctioned is formed on the rear plate.

The charger may further comprise an AC module accommodated between the pair of side plates and at least one power module disposed on the upper side of the AC module.

The filter may be spaced from the AC module in the left and right direction.

Air suctioned into the suction port may flow to the AC module after passing through the filter.

The power module may comprise an inner fan configured to flow air in inner space inside the power module.

The cabinet body may be formed with a discharge port for discharging air from the inner space to the outside.

A first distance between a front end of the filter and one of the pair of side plates may be shorter than a second distance between a rear end of the filter and one of the pair of side plates.

The charger may comprise an air guide configured to guide air suctioned into the suction port to the filter.

The suction port may comprise a plurality of suction holes.

The moisture suctioned into the suction port may be discharged through a lower suction hole among a plurality of suction holes by the air guide.

The charger may further comprise at least one wing disposed inside the air guide to prevent moisture from penetrating.

The at least one wing may be disposed to be long in the left and right direction.

The charger may further comprise a filter cap. The filter cap may be rotatably connected to the air guide. The filter cap may have an opening formed therein through which air passing through the filter passes.

The air guide may have an inlet flow path through which air suctioned in through the suction port is guided in the left and right direction, and an outlet flow path through which air passed through the inlet flow path is guided in the front and rear direction.

The air guide may comprise a rear guide facing the rear plate and guiding air suctioned into the suction port; and a side guide facing one of the pair of side plates and guiding air guided to the rear guide to the filter.

The side guides may be formed to become gradually smaller as it goes forward.

At least one wing may be disposed inside the rear guide to prevent moisture from penetrating.

The at least one wing may comprise a rear wing facing the suction port; and a front wing connected to the rear wing and inclined in the opposite direction to the rear wing.

The at least one wing may further comprise an upper extension extending upward from an area where the rear wing and the front wing are connected.

### BRIEF DESCRIPTION OF THE DRAWINGS

FIG. 1 is an exploded perspective view illustrating an example of a charger according to the present embodiment,

FIG. 2 is a side view illustrating a charger body according to the present embodiment,

FIG. 3 is a rear view illustrating the charger body according to the present embodiment,

FIG. 4 is a front view illustrating the interior of an example of a charger according to the present embodiment,

FIG. 5 is a cross-sectional view taken along line A-A line illustrated in FIG. 4,

FIG. 6 is a perspective view illustrating a power module according to the present embodiment,

FIG. 7 is a partially cut-away perspective view illustrating an air guide according to the present embodiment,

FIG. 8 is a view illustrating an air guide and a wing according to the present embodiment,

FIG. 9 is a view illustrating air flow in an example of a charger according to the present embodiment,

FIG. 10 is a cross-sectional view taken along B-B line illustrated in FIG. 9,

FIG. 11 is a front view illustrating the interior of a first modified example of a charger according to the present embodiment, and

FIG. 12 is a front view illustrating the interior of a second modified example of a charger according to the present embodiment.

### DETAILED DESCRIPTION OF THE EMBODIMENTS

Hereafter, specific embodiments of the present disclosure will be described in detail with reference to the drawings.

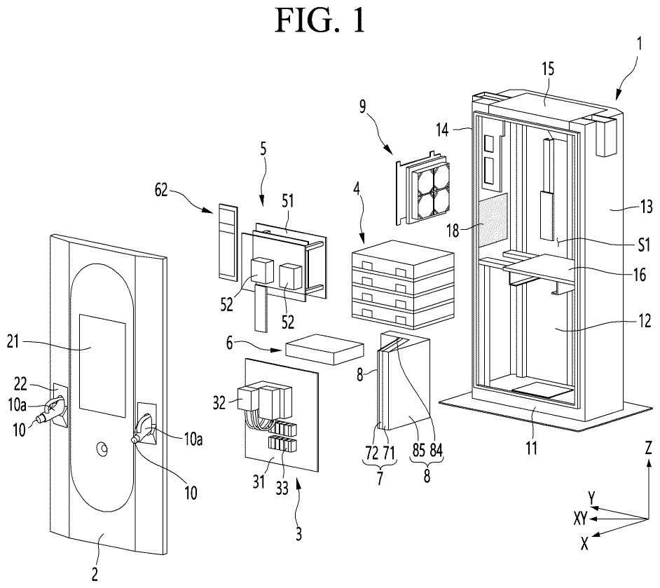

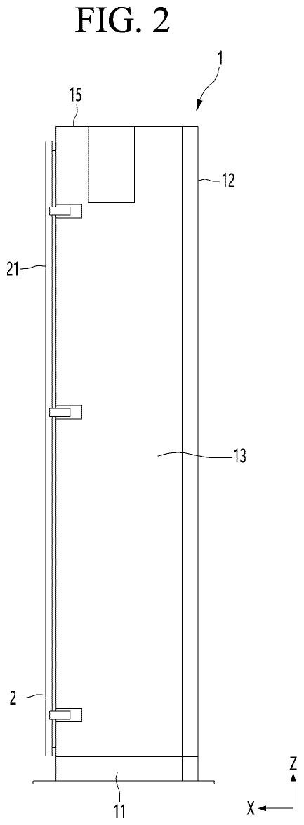

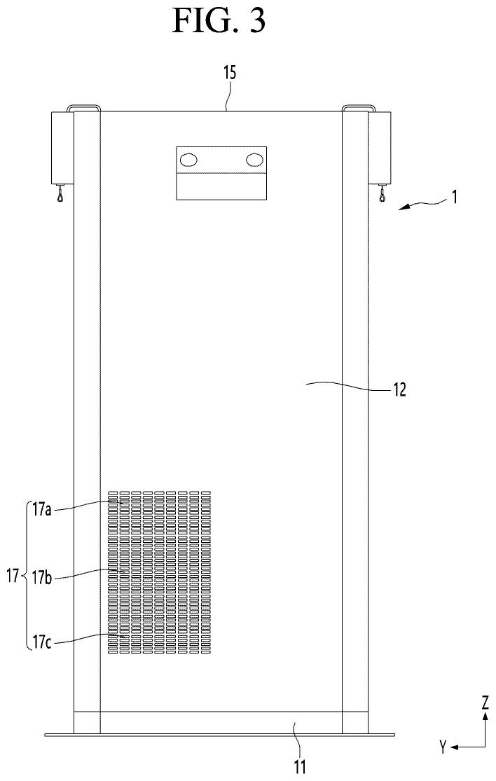

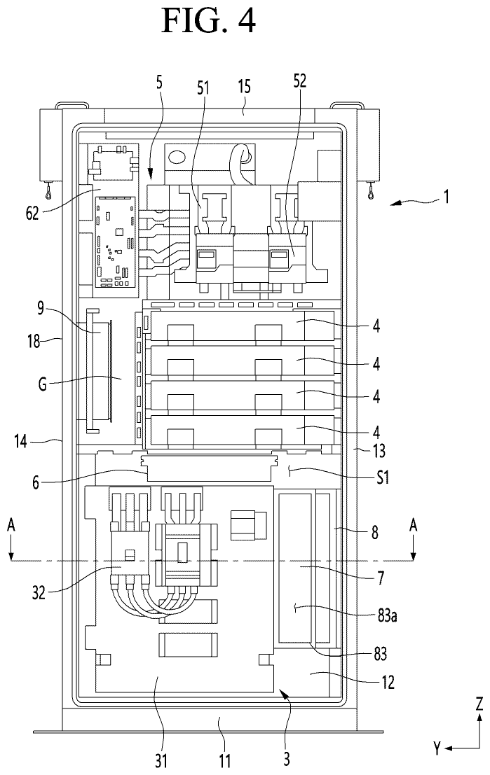

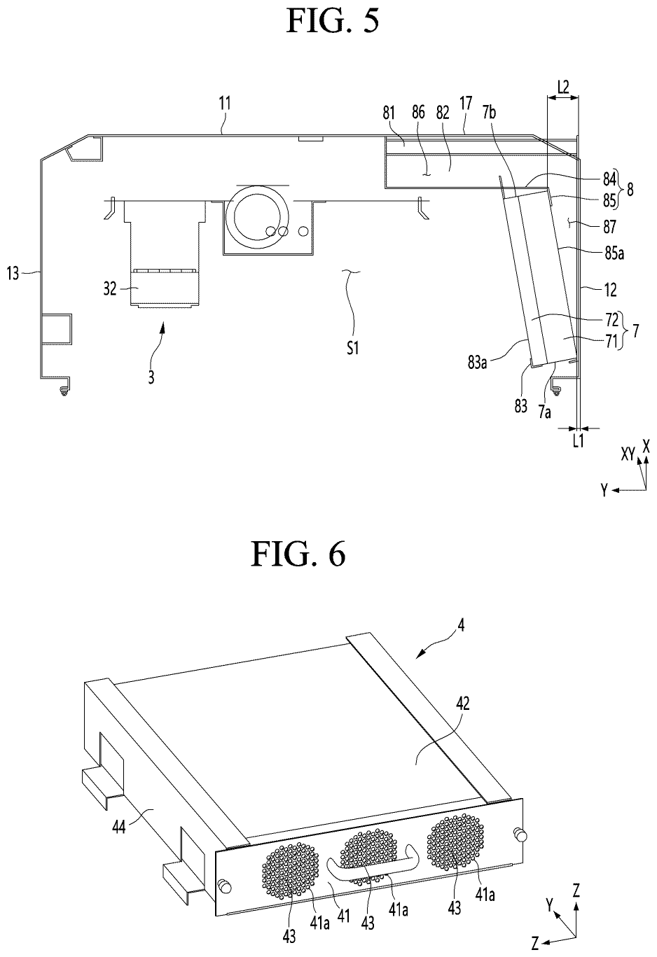

FIG. 1 is an exploded perspective view illustrating an example of a charger according to the present embodiment, FIG. 2 is a side view illustrating a charger body according to the present embodiment, FIG. 3 is a rear view illustrating the charger body according to the present embodiment, FIG. 4 is a front view illustrating the interior of an example of a charger according to the present embodiment, FIG. 5 is a cross-sectional view taken along line A-A illustrated in FIG. 4, and FIG. 6 is a perspective view illustrating a power module according to the present embodiment.

An example of a charger may comprise a cabinet body 1.

The cabinet body 1 may be the main body of a charger.

The cabinet body 1 may form an outer appearance of a lower surface of an example of a charger. The cabinet body 1 may form an outer appearance of the rear surface of an example of a charger. The cabinet body 1 may form an outer appearance of the side of an example of a charger. The cabinet body 1 may form an outer appearance of the upper surface of an example of a charger.

An inner space S1 may be formed inside the cabinet body 1, and the front surface of the cabinet body 1 may be opened.

The cabinet body 1 may comprise a base 11, a rear plate 12, a pair of side plates 13, 14, and a top cover 15.

The inner space S1 may be formed between the base 11 and the top cover 15.

The rear plate 12 may be erected on the upper side of the base 11.

Each of the pair of side plates 13, 14 may be erected on the upper side of the base 11.

The pair of side plates 13, 14 may be spaced apart in the left and right direction Y.

The inner space S1 may be formed between the pair of side plates 13, 14.

The pair of side plates 13, 14 may comprise a left plate 13 and a right plate 14, and the left plate 13 and the right plate 14 may be spaced apart in the left and right direction Y.

The inner space S1 may be formed between the left plate 13 and the right plate 14.

One of the left plate 13 and the right plate 14 may be a proximate plate close to the filter 7, and the other of the left plate 13 and the right plate 14 may be distal to the filter 7.

The top cover 15 may connect the upper end of the left plate 13 and the upper end of the right plate 14. The top cover 15 may cover the area between the upper end of the left plate 13 and the upper end of the right plate 14.

A power module holder 16 may be placed inside the cabinet body 1. The power module holder 16 may be accommodated in the inner space S1.

The cabinet body 1 may be formed with a suction port 17 through which air from outside the cabinet body 1 is suctioned in. The suction port 17 may be formed in the rear plate 12. The suction port 17 may not be formed in the pair of side plates 13,14. An example of a charger may suction in air to the rear surface.

The suction port 17 may be formed eccentrically to the rear plate 12. The suction port 17 may be closer to the proximate plate than to the distal plate.

The suction port 17 may comprise a plurality of suction holes 17a, 17b, 17c formed in the rear plate 12.

The suction holes 17a, 17b, 17c may be opened on the rear plate 12 in the front and rear direction X.

The suction holes 17a, 17b, 17c may penetrate the front and rear surfaces of the rear plate 12.

Air outside the cabinet body 1 may flow in the front and rear direction X, pass through the suction holes 17a, 17b, 17c, and be suctioned into the cabinet body 1.

A plurality of suction holes 17a, 17b, 17c may be divided into an upper suction hole 17a, a middle suction hole 17b, and a lower suction hole 17c.

The upper suction hole 17a may be a suction hole with a high height among the suction holes 17a, 17b, 17c.

The middle suction hole 17b may be a suction hole that is lower in height than the upper suction hole 17a and higher in height than the lower suction hole 17c.

The lower suction hole 17 may be a suction hole with a lower height among the suction holes 17a, 17b, 17c.

A discharge port 18 through which air in the inner space S1 is discharged to the outside of the cabinet body 1 may be formed in the cabinet body 1. The discharge port 18 may be formed in the left plate 13 or the right plate 14. The discharge port 18 may be formed in the plate that is further from the filter 7 among the left plate 13 and the right plate 14.

The discharge port 18 is not formed in the plate close to the filter 7 among the left plate 13 and the right plate 14, and the discharge port 18 may be formed in the plate far from the filter 7 among the left plate 13 and the right plate 14. The discharge port 18 may be formed in the distal plate.

When the filter 7 is closer to the left plate 13 among the left plate 13 and the right plate 14, the suction port 17 may be closer to the left plate 13, and the discharge port 18 may be formed in the right plate 14.

When the filter 7 is closer to the right plate 14 among the left plate 13 and the right plate 14, the suction port 17 may be closer to the right plate 14, and the discharge port 18 may be formed in the left plate 13.

An example of a charger may further comprise a front door 2.

The front door 2 may be placed at the front of the cabinet body 1. The front door 2 may open and close the inner space S1.

The front door 2 may form the outer appearance of the front surface of an example of a charger.

A display 21 that displays various information may be placed on the front door 2.

A holder 22 on which a connector 10a of a charging cable 10 is hold may be placed on the front door 2.

An example of a charger may further comprise an AC module 3.

The AC module 3 may be accommodated in the inner space S1. The AC module 3 may be accommodated between a pair of side plates 13, 14.

The AC module 3 may control AC power. The AC module 3 may comprise a plate 31 and a circuit breaker 32.

The plate 31 may be mounted on the cabinet body 1 or an inner frame accommodated within the cabinet body 1. The plate 31 may be a lower plate disposed on the lower portion of the upper and lower portions of the cabinet body 1. The material of the plate 31 may be a metal material.

The plate 31 may be equipped with various components capable of controlling AC power.

The circuit breaker 32 may be placed on the front surface of the plate 31.

The circuit breaker 32 may cut off the AC power supplied from the outside. The circuit breaker 32 may cut off the AC power when excessive power is applied to the cable to which the AC power is applied.

The AC module 3 may further comprise a power line bridge 33.

A power line bridge 33 may be placed on the front surface of the plate 31. An external power line and an internal power line may be connected to the power line bridge 33.

An example of a charger may further comprise a power module 4.

The power module 4 may be a module that supplies charging power to an electric vehicle. The power module 4 may convert AC power into DC power.

The power module 4 may have a predetermined output, and an example of a charger may comprise a plurality of power modules 4.

A plurality of power modules 4 may be stacked in the vertical direction Z.

The power module holder 16 supporting a plurality of power modules 4 may be placed in the inner space S1 of the cabinet body 1, and the plurality of power modules 4 may be placed on the power module holder 16 and accommodated in the inner space S1.

The power module 4 may be placed above the AC module 3. The height of the power module 4 may be higher than the height of the AC module 3.

The power module 4 may comprise a suction plate 41 and a module body 42, as illustrated in FIG. 6.

An inner suction hole 41a may be formed in the suction plate 41, and air in the inner space S1 may flow inside the module body 42 through the inner suction hole 41a.

The suction plate 41 may be closer to the proximate plate among the proximate plate and the distal plate.

The module body 42 may form the outer appearance of the power module 4. A space through which air may pass may be formed inside the module body 42.

The power module 4 may further comprise a converter disposed in space in the module body 42. The converter may convert AC power into DC power.

The power module 4 may comprise an inner fan 43. The inner fan 43 may cause air in the inner space S1 to flow inside the power module 4. The inner fan 43 may be placed between the suction plate 41 and the converter.

When the inner fan 43 is driven, air in the inner space S1 may flow into the interior of the module body 42 through the inner suction hole 41a, cool electrical components such as a converter disposed in the space of the module body 42 by air cooling, and may be exhausted to the outside of the module body 42.

The power module 4 may further comprise a bracket 44 that supports the module body 42.

An example of a charger may further comprise a DC module 5.

The DC module 5 may be a module that distributes power to aa plurality of charging cables 10.

The DC module 5 may be disposed above the power module 4. The height of the DC module 5 may be higher than the height of the power module 4.

The DC module 5 may comprise a plate 51 and a meter 52.

The plate 51 may be mounted on the cabinet body 1 or an inner frame accommodated within the cabinet body 1. The plate 51 may be an upper plate disposed on the upper part of the upper and lower parts of the cabinet body 1. The material of the plate 51 may be a metal material.

The plate 51 may be equipped with various components capable of controlling DC power.

The meter 52 may be disposed on the front surface of the plate 51.

The meter 52 may measure the consumption of direct current power supplied through the charging cable 10.

The DC module 5 may comprise a distribution part that distributes direct current power to a plurality of charging cables 10.

An example of a charger may further comprise a PSU 6.

The PSU 6 may be a power supply unit such as a charger. The PSU 6 may be disposed on the lower side of the power module 4. The PSU 6 may be disposed on the lower side of the power module holder 16.

An example of a charger may further comprise a control board 62.

The control board 62 may control the overall operation of the charger. The control board 62 may control the display 22.

The control board 62 may be accommodated in the inner space S1. The control board 62 may be close to the DC module 5 among the AC module 3 and the DC module 5.

An example of a charger may further comprise a filter 7 and an air guide 8.

The filter 7 may be an inner filter accommodated in the inner space S1. A plurality of filters 7 may be accommodated in the inner space S1.

The filter 7 may play a role in blocking dust and fine dust. The filter 7 may be a filter that purifies air introduced into the inner space S1. The filter 7 may be a filter that removes salt from air introduced into the inner space S1.

The filter 7 may be withdrawn to the outside through the open front surface of the cabinet body 1 and may be inserted into the inner space S1 through the open front surface of the cabinet body 1.

The filter 7 may be tilted toward the front surface of the rear plate 12 and disposed next to the inner surface of one of a pair of side plates 13, 14.

The filter 7 may not be positioned in the center of the inner space S1, but may be positioned closer to either the left plate 13 or the right plate 14.

The filter 7 may be mounted on the air guide 8. The filter 7 may be supported on the air guide 8.

The filter 7 may be tilted toward the front surface of the rear plate 12 next to the inner surface of one of the pair of side plates 13, 14 when disposed on the air guide 8.

When the filter 7 is tilted, the filter 7 may be disposed to be long in the oblique direction XY between the front and rear direction X and the left and right direction Y.

When the filter 7 is disposed to be long in the oblique direction XY, the area of the filter 7 may be wider than when the filter 7 is disposed to be long in the front and rear direction X or in the left and right direction Y, and in the charger, for example, when the filter 7 is disposed to be long in the oblique direction XY, the capacity of the filter 7 may be higher.

A first distance L1 between the front end 7a of the filter 7 and one of the pair of side plates 13, 14 may be shorter than a second distance L2 between the rear end 7b of the filter 7 and one of the pair of side plates 13, 14.

One of the pair of side plates 13, 14 may be a proximate plate, and a first distance L1 between the front end 7a of the filter 7 and the proximate plate may be shorter than a second distance L2 between the rear end 7b of the filter 7 and the proximate plate.

The filter 7 may be spaced apart from the AC module 3 in the left and right direction Y.

A plurality of filters 7 may be disposed in the inner space S1.

The plurality of filters 7 may comprise a pre-filter 71 and a medium filter 72.

The pre-filter 71 may be placed before the medium filter 72 in the direction of air flow. The pre-filter 71 may filter out foreign substances such as dust mixed in the air.

The medium filter 72 may be placed after the pre-filter 71 in the direction of air flow.

The air guide 8 may guide air suctioned into the suction port 17 to the filter 7.

The air guide 8 may be directed toward a plurality of suction holes 17a, 17b, 17c and may guide air suctioned into the a plurality of suction holes 17a, 17b, 17c.

The air guide 8 may be disposed close to the rear plate 12. The air guide 8 may discharge moisture suctioned in through the suction port 17 to the lower suction hole 17c among the plurality of suction holes 17a, 17b, 17c.

The height of the lower plate 81 of the air guide 8 may be lower than the height of the lower suction hole 17c, and the lower plate 81 of the air guide 8 may guide moisture that has penetrated into the air guide 8 to the lower suction hole 17c.

Moisture introduced through the plurality of suction holes 17a, 17b, 17c may fall to the lower plate 81 of the air guide 8, be guided along the lower plate 81 of the air guide 8 to the lower suction hole 17c, and be discharged to the outside through the lower suction hole 17c.

The lower plate 81 of the air guide 8 may be a moisture guide that guides moisture to the lower suction hole 17c.

An example of a charger may further comprise at least one wing 82.

The at least one wing 82 may be disposed inside the air guide 8 to prevent moisture from penetrating.

The at least one wing 82 may act as a louver and shield water from penetrating from the outside.

An example of a charger may further comprise a filter cap 83.

The filter cap 83 may be rotatably connected to the air guide 8.

The filter cap 83 may retain the filter 7 by restraining the filter 7 so that the filter 7 is not arbitrarily removed. The filter 7 may be maintained between the air guide 8 and the filter cap 83.

The filter cap 83 may be disposed at the same angle as the filter 7.

An opening 83a through which air passing through the filter 7 passes may be formed in the filter cap 83.

As the filter 7 is disposed tilted and the filter 7 is spaced apart from the AC module 3 in the left and right direction Y, the empty space between the filter 7 and the AC module 3 may become a rotational space in which the filter cap 83 rotates.

When the filter cap 83 is rotated in the rotation space, the filter cap 83 may be disposed approximately in the front and rear direction X, and the front portion of the filter cap 83 may be moved away from the air guide 8.

A gap is created between the front portion of the filter cap 83 and the air guide 8 through which the filter 7 may be entered and exited in the front and rear direction, and the filter 7 may be easily inserted and removed in the front and rear direction through the gap formed between the filter cap 83 and the air guide 8.

The filter 7 may be pulled out to the front of the cabinet body 1 through the gap between the filter cap 83 and the air guide 8, and may be inserted to the rear through the gap between the filter cap 83 and the air guide 8.

The air guide 8 may be formed into a shape that may minimize moisture penetration.

The air guide 8 may be a filter frame that supports the filter 7. The filter 7 may be mounted on the air guide 8.

The air guide 8 may comprise a rear guide 84 and a side guide 85.

The rear guide 84 faces the rear plate 12, and air suctioned into the suction port 17 may be guided to the side guide 85 by the rear guide 84.

The rear guide 84 may face the suction port 17 in the front and rear direction X.

The at least one wing 82 may be disposed inside the rear guide 84 to prevent moisture from penetrating.

As the wing 82 and the rear guide 84 are disposed in front of the rear plate 12 and the suction port 17 is formed in the rear plate 12, the outer appearance of the pair of side plates 13, 14 and the outer appearance of the front door 2 may be enhanced.

The side guide 85 may face one of the pair of side plates 13, 14. The side guide 85 may face one of the pair of side plates 13, 14 in the left and right direction Y. The side guide 85 may guide the air guided to the rear guide 84 to the filter 7. The side guide 85 may be formed in a bent shape with the rear guide 84.

The side guide 85 may be bent forward on one side of the rear guide 84.

The side guide 85 may be formed to become gradually smaller as it goes forward.

An outlet 85a through which air passes may be formed in the side guide 85. Air guided to the side guide 85 may flow to the filter 7 through the outlet 85a.

The air guide 8 may be a filter frame that supports the filter 7. The filter 7 may be mounted on the air guide 8. A filter supporter that supports the filter 7 may be formed on the air guide 8.

The filter 7 may be disposed on the side guide 85. The filter supporter may be formed on the side guide 85. The filter 7 may be seated on the filter supporter and accommodated in the filter supporter.

The filter supporter may be formed to be bent or protruded from the side guide 85.

When the filter 7 is placed on the side guide 85, the filter 7 may be easily entered and exited through the filter supporter through the front surface of the cabinet body 1, and maintenance of the filter 7 may be easy.

A flow path 86, 87 through which air passes may be formed in the air guide 8.

The flow path 86, 87 may be formed inside the air guide 8.

The flow path 86, 87 may be divided into an inlet flow path 86 and an outlet flow path 87.

The inlet flow path 86 may guide air suctioned into the suction port 17 in the left and right direction Y.

The inlet flow path 86 may be formed in the rear guide 84. The inlet flow path 86 may be formed long inside the rear guide 84 in the left and right direction Y.

The outlet flow path 87 may guide the air passing through the inlet flow path 86 in the front and rear direction X.

The outlet flow path 87 may be formed in the side guide 84. The outlet flow path 87 may be formed long inside the side guide 84 in the front and rear direction X.

The front end cross-sectional area of the outlet flow path 87 may be smaller than the rear end cross-sectional area of the outlet flow path 87.

The cross-sectional area of the outlet flow path 87 may be gradually reduced in the forward direction.

An example of a charger may further comprise a fan 9.

The fan 9 may discharge air in the inner space S1 to the discharge port 18. The fan 9 may discharge air that has passed through the inside of the power module 4 to the discharge port 18. The fan 9 may be placed between the power module 4 and the discharge port 18. The fan 9 may face the power module 4 and the discharge port 18 in the left and right direction Y.

The fan 9 may comprise an outer fan. The outer fan 9 may be spaced apart from the power module 4 in the left and right direction Y.

A gap G may exist between the fan 9 and the power module 4. Air in the inner space S1 may flow to the fan 9 through the gap G. Air passing through the power module 4 may flow to the fan 9 through the gap G.

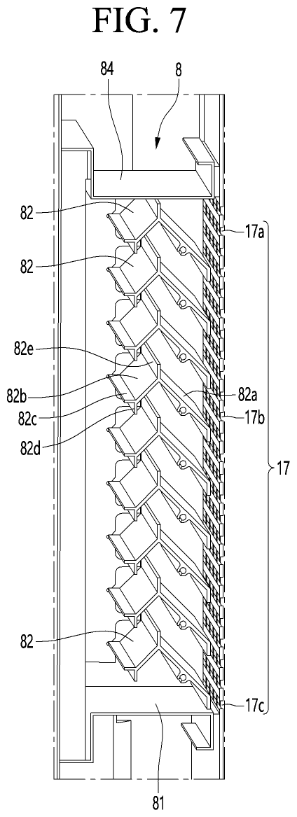

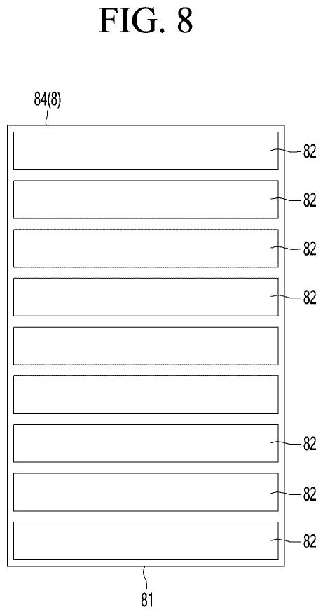

FIG. 7 is a partially cut-away perspective view illustrating an air guide according to the present embodiment, and FIG. 8 is a view illustrating an air guide and a wing according to the present embodiment.

The wing 82 may be accommodated inside the air guide 8.

The wing 82 may block moisture passing through a plurality of suction holes 17a, 17b, 17c and prevent moisture from penetrating.

The wing 82 may be fixedly installed on the air guide 8. The wing 82 may be disposed to be long in the left and right direction Y. When the wing 82 is long in the left and right direction Y, the number of wings 82 may be minimized, fastening members such as screws for fastening the wing 82 to the air guide 8 may be minimized, and the manufacturing process of the charger may be minimized.

A plurality of wings 82 may be disposed on the air guide 8. A gap (or slit) may be formed between adjacent pairs of wings among the plurality of wings 82.

The cross-sectional shape of the gap (or slit) formed between a pair of wings 82 may be a “∧” shape, and air suctioned into the air guide 8 may flow through the gap, and moisture may be blocked by the wing 82.

The wing 82 may have a three-dimensional shape.

The wing 82 may comprise a rear wing 82a and a front wing 82b.

The rear wing 82a may be directed toward the suction port 17. The rear wing 82a may be formed to be inclined. The distance between the upper end of the rear wing 82a and the suction port 17 may be longer than the distance between the lower end of the rear wing 82a and the suction port 17.

The upper end of the front wing 82b may be connected to the upper end of the rear wing 82a. The front wing 82b may face the air guide 8. The front wing 82b may be inclined in the opposite direction to the rear wing 82a. The distance between the upper end of the front wing 82b and the air guide 8 may be longer than the distance between the lower end of the front wing 82b and the air guide 8. The front surface of the front wing 82b may face the inclined direction toward the upper front side.

The wing 82 may further comprise a front extension 82c extending in a forward direction.

The front extension 82c may extend forward from the lower end of the front wing 82b.

The wing 82 may further comprise a lower extension 82d extending downward.

The lower extension 82d may extend downward from the lower end of the front wing 82b.

The wing 82 may further comprise an upper extension part 82e extending upward.

The upper extension 82e may extend upward in the area where the rear wing 82a and the front wing 82b are connected.

The wing 82 may be disposed to be long inside the rear guide 84 in the left and right direction Y.

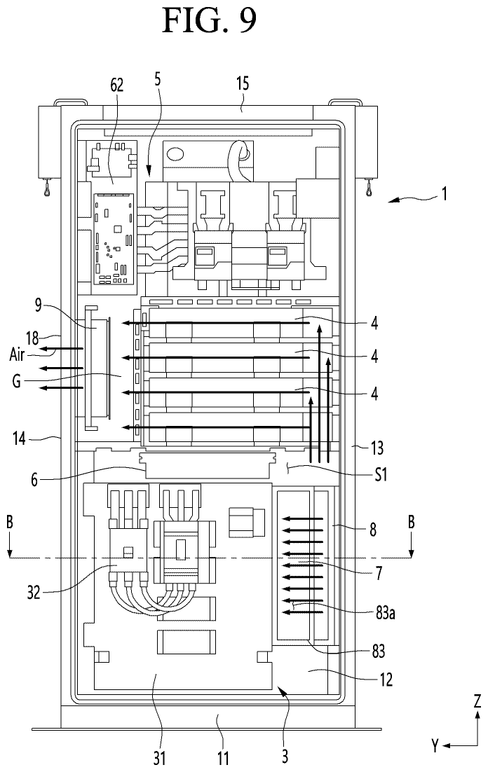

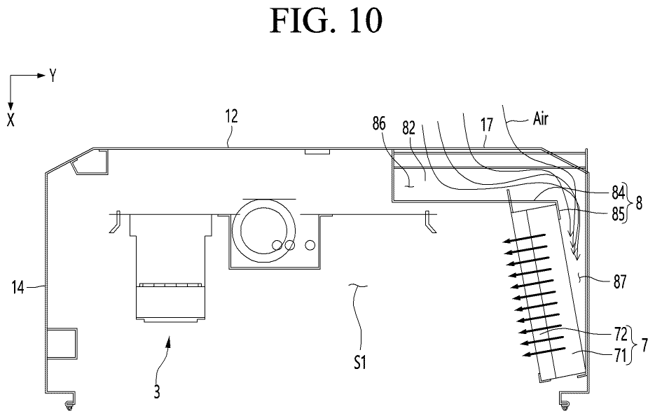

FIG. 9 is a view illustrating air flow in an example of a charger according to the present embodiment, and FIG. 10 is a cross-sectional view taken along the B-B line illustrated in FIG. 9.

When the outer fan 9 and the inner fan 43 of the power module 4 are driven, a negative pressure is formed in the inner space S1 of the cabinet body 1 and the flow path 86, 87 of the air guide 8, and air outside the cabinet body 1 may be suctioned into the suction port 17.

Air suctioned into the suction port 17 is guided to the rear guide 84 and wing 82 to flow in the left and right direction Y, and then is guided to the side guide 85 to flow in the front and rear direction X.

In other words, the air guided to the air guide 8 may flow in an ‘ [symbol] ’ shape by converting the flow direction, and then flow outside the side guide 85, and after passing through the filter 7, may flow to the AC module 3.

Air flowing into the AC module 3 may cool the AC module 3, and then be suctioned into the interior of the power module 4 by the inner fan 43, and may cool the power module 4 while passing through the power module 4.

Air passing through the power module 4 may flow to the discharge port 18 by the fan 9 and discharged outside the cabinet body 1 through the discharge port 18.

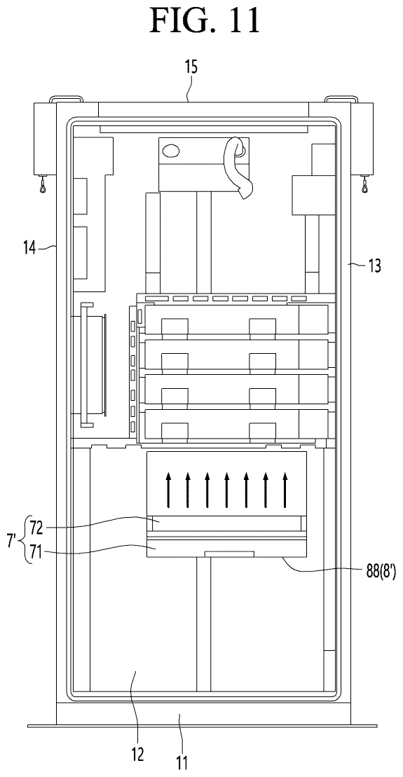

FIG. 11 is a front view illustrating the interior of a first modified example of a charger according to the present embodiment.

A first modified example of the charger may comprise a filter 7′ disposed horizontally in the inner space S1 and an air guide 8′ that guides air suctioned into the suction port 17 of the cabinet body 1 to the filter 7′.

The filter 7′ may be disposed on the upper side of the air guide 8′.

The filter 7′ may comprise a pre-filter 71 disposed above the air guide 8′ and a medium filter 72 disposed above the pre-filter 71.

The air guide 8′ may be disposed between the left plate 13 and the right plate 14.

The air guide 8′ may comprise a rear guide and a front guide 88.

The rear guide may guide air to the front guide 88.

The rear guide may accommodate a wing.

The front guide 88 may guide air upward.

The first modified example of the charger is different from the example of the charger in terms of the disposition direction of the filter 7′ and the air guide direction of the air guide 8′, and since other configurations and operations are the same or similar to those of the example of the charger, the same symbols are used and a detailed description thereof is omitted to avoid duplicate descriptions.

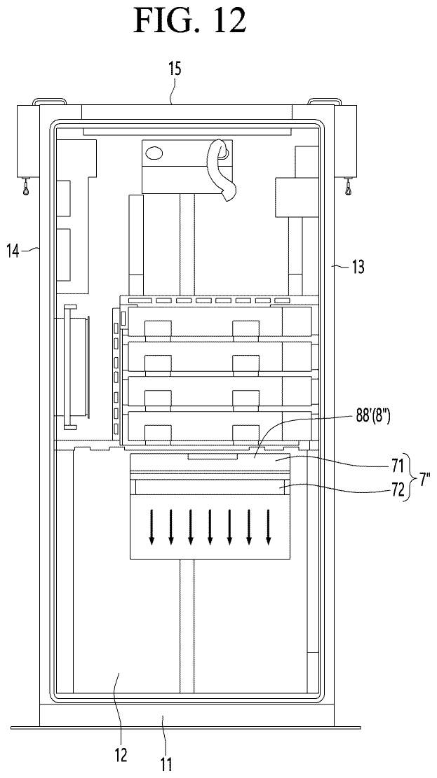

FIG. 12 is a front view illustrating the interior of a second modified example of a charger according to the present embodiment.

A second modified example of the charger may comprise a filter 7″ disposed horizontally in the inner space S1 and an air guide 8″ that guides air suctioned into the suction port 17 of the cabinet body 1 to the filter 7′.

The filter 7″ may be placed on the lower side of the air guide 8″.

The filter 7″ may comprise a pre-filter 71 positioned below the air guide 8″ and a medium filter 72 positioned below the pre-filter 71.

An air guide 8″ may be placed between the left plate 13 and the right plate 14.

The air guide 8″ may comprise a rear guide and a front guide 88′.

The rear guide may guide air to the front guide 88′.

The rear guide may accommodate a wing.

The front guide 88′ may guide air in a downward direction.

The first modified example of the charger is different from the example of the charger in terms of the disposition direction of the filter 7″ and the air guide direction of the air guide 8″, and since other configurations and functions are the same or similar to those of the example of the charger, the same symbols are used and a detailed description thereof is omitted to avoid duplicate descriptions.

According to this embodiment, the suction port is formed on the rear plate of the cabinet body, thereby enhancing the front outer appearance of the charger.

In addition, the filter is disposed tilted toward the front surface of the rear plate and is disposed next to an inner side of one of the pair of side plates, which allows for maximizing the size of the filter and slimming the charger in the front and rear direction.

In addition, the inlet and outlet flow paths formed inside the air guide are orthogonal to each other, so that the moisture may be minimized.

In addition, the wing disposed inside the rear guide of the air guide may more effectively block moisture.

In addition, the side guides of the air guide are formed to become gradually smaller as it goes forward, thereby increasing the space utilization of the inner space.

In addition, the AC module and filter are spaced apart in the left and right direction, allowing the filter to be separated or mounted more easily.

In addition, air passing through the filter may flow to the AC module to dissipate heat from the AC module, minimizing damage to the AC module and the risk of fire.

The description is merely an illustrative explanation of the technical idea of the present disclosure, and various modifications and variations will be possible to those skilled in the art without departing from the essential characteristics of the present disclosure.

Accordingly, the embodiments disclosed in the present disclosure are not intended to limit the technical idea of the present disclosure, but are for illustrative purposes, and the scope of the technical idea of the present disclosure is not limited by these embodiments.

The scope of protection of the present disclosure should be interpreted in accordance with the claims below, and all technical ideas within the equivalent scope should be interpreted as being comprised in the scope of rights of the present disclosure.

What is claimed is:

1. A charger comprising:
a cabinet body, the cabinet body including:
a first side plate;
a second side plate spaced apart from the first side plate in a first direction; and
a rear plate, the rear plate including a suction port configured to allow air to be suctioned therethrough,
wherein the first side plate, the second side plate and the rear plate define an inner space of the cabinet; and
a filter located adjacent to an inner side of the first side plate, the filter being tilted toward a front surface of the rear plate.

2. The charger of claim 1, further comprising:
an air conditioning (AC) module accommodated between the first side plate and the second side plate; and
at least one power module disposed on an upper side of the AC module;
wherein the filter is spaced apart from the AC module in the first direction.

3. The charger of claim 2, further comprising a discharge port located on the cabinet body, the discharge port being configured to discharge air from the inner space to outside the cabinet body,
wherein air suctioned into the suction port passes through the filter and then flows to the AC module, and
wherein the at least one power module comprises an inner fan configured to direct air in the inner space to inside the at least one power module.

4. The charger of claim 1, wherein a first distance between a front end of the filter and the first side plate is shorter than a second distance between a rear end of the filter and the first side plate.

5. The charger of claim 1, further comprising an air guide configured to guide suctioned air from the suction port to the filter.

6. The charger of claim 5, wherein the suction port comprises a plurality of suction holes, and
wherein the air guide is configured to discharge moisture in the suctioned air through a lower suction hole among the plurality of suction holes.

7. The charger of claim 5, further comprising at least one wing located inside the air guide, the at least one wing being configured to direct moisture in the suctioned air towards the lower suction hole.

8. The charger of claim 7, wherein the at least one wing extends in the first direction.

9. The charger of claim 5, further comprising a filter cap pivotally connected to the air guide, the filter cap having an opening configured to allow the suctioned air passing through the filter to pass therethrough.

10. The charger of claim 5, wherein the air guide comprises:
an inlet flow path configured to guide the suctioned air in the first direction; and
an outlet flow path configured to guide the suctioned air that has passed through the inlet flow path in a second direction perpendicular to the first direction.

11. The charger of claim 5, wherein the air guide comprises:
a rear guide facing the rear plate, the suctioned air being guided along the rear guide; and
a side guide directed toward the first side plate, the side guide being configured to guide the suctioned air guided along the rear guide to the filter.

12. The charger of claim 11, wherein a thickness of the side guide gradually decreases in a direction towards a front of the cabinet.

13. The charger of claim 11, further comprising at least one wing located inside the rear guide, the al least one wing being configured to direct moisture towards the suction port.

14. The charger of claim 13, wherein the at least one wing comprises:
a rear wing facing the suction port, the rear wing having a first incline; and
a front wing connected to the rear wing, the front wing having a second incline in a direction opposite to the first incline.

15. The charger of claim 14, wherein the at least one wing further comprises an upper extension extending upward from an area where the rear wing and front wing are connected.

16. The charger of claim 1, wherein the cabinet body further comprises:
a front door located opposite the rear plate; and
at least one connector located on the front door, the at least one connector being configured to be connected to a charging cable.

17. The charger of claim 16, further comprising a display located on the front door of the cabinet body.

18. A charger comprising:
a cabinet body, the cabinet body including:
a first side plate;
a second side plate spaced apart from the first side plate in a first direction; and
a rear plate, the rear plate including a suction port configured to allow air to be suctioned therethrough,
wherein the first side plate, the second side plate and the rear plate define an inner space of the cabinet; and
an air guide located in the inner space of the cabinet, the air guide including at least one wing extending in the first direction, the air guide being configured to discharge moisture in the suctioned air towards the suction port.

19. The charger of claim 18, wherein the air guide further comprises:
an inlet flow path configured to guide the suctioned air in the first direction; and
an outlet flow path configured to guide the suctioned air that has passed through the inlet flow path in the second direction.

20. The air guide of claim 18, wherein the at least one wing comprises:
a rear wing facing the suction port, the rear wing having a first incline; and
a front wing connected to the rear wing, the front wing having a second incline in a direction opposite to the first incline.
